(19) United States
(12) Patent Application Publication
(10) Pub. No.: US 2006/0140597 A1
(43) Pub. Date: Jun. 29, 2006

(54) Decorative coverage and snow melting system

(76) Inventor: Nir Heumann, Ramat Gan (IL)

Correspondence Address: Edward Langer;c/o Shiboleth, Yisraeli, Roberts, Zisman & Co., 60th Floor, 350 Fifth Avenue, New York, NY, 10118, US

(21) Appl. No.: 11/020,175

(22) Filed: Dec. 27, 2004

(51) Int. Cl. H05B 3/00

(52) U.S. Cl. 392/435; 219/213

(57) ABSTRACT

A modular coverage system for covering an area of desired shape and size with the purpose of heating the said area in order to prevent snow accumulation or to melt down accumulated snow or for decoration, protection and comfort, comprising a plurality of generally planar surface units suitable to be laid out adjacent to each other that may be made with different decorative patterns. In snow melting systems electric conducting and heating means are located inside the surface unit. Along the outline of the surface unit recessed docking station means are provided in the areas that are designed to be adjacent to the outline of a neighboring surface unit. Each docking station means comprises electrical connection means and one or more mechanical engagement means. Units are interconnected by removable integral connecting plates with electrical connection means and mechanical engagement means inserted from above and received in the docking station areas. A removable docking station cover panel is used to cover docking station means that remain unattached, and keep them watertight. An electrical docking station cover panel with electrical connection means may be attached to a docking station means in a surface unit positioned at any convenient location within the snow melting system to connect the snow melting system to a power source. The electric means in the surface units are connected in a parallel circuit such that electricity supply persists in the event of failure in one of the surface units. The modular coverage system may be made without electrical and heating means to be used for decorative and protective purposes.

### BACKGROUND OF THE INVENTION

The need to keep outdoor areas, driveways, sidewalks and stairs around houses or business premises free of snow while eliminating the need for repetitive heavy manual work gave rise to a large variety of products such as the car snowplow, home snow throwers and similar mechanical solutions that at the end of the day still require time consuming handling and operating. A further disadvantage of these devices is that they neither prevent the snow accumulating nor remove it but rather push it further away from the cleaned area.

A much more advanced and work saving solution was achieved by the introduction of electrically operated snow melting systems. These systems are intended to melt away the snow without the need for exerting further efforts either manually or mechanically and they will perform the task of keeping a driveway, a road or a parking lot clean of snow or ice in the absence of the owner, thereby liberating him from the tedious everyday chore of snow clearing.

Electric snow melting systems may also be installed on roofs to prevent them from freezing or accumulating excessive amounts of snow.

The electric snow melting systems known in the art are however characterized by diverse disadvantages that need to be overcome before an efficient and convenient to install and to use system can be achieved while keeping production and installation costs at a low level.

Thus embedded snow melting systems need to be installed underneath the concrete or asphalt or any other paving material, such underground installation involving many complications and necessitating the hiring of a constructor with heavy machinery equipment. This is the most common solution in the market as to date even though it requires highly time consuming and costly planning, contracting, building and installation procedures. It is a further disadvantage of these systems that installation may give rise to various technical problems such as cable dislocation during asphalt pouring and access for maintenance is complicated.

Embedded roof coverage melting systems are similarly costly, time consuming and necessitating professional help for maintenance while external systems for roofs are characterized by visible cables that create an esthetically imperfect look while also causing accumulation of dry leaves and dirt. At the same time these systems have an insufficient melting, effect such that a few inches away from the cables snow remains unaffected. The procedure of installing an embedded roof coverage melting system is made even more expensive and lengthy due to the fact that it involves replacing or removing and reinstalling the roof tiles.

A further solution of the prior art is electric melting mats. These mats come in predefined size and shape and do not suit non-straight shapes. Because they are not firm they are unsuitable for covering driveways. It is impossible to use such mats to cover large areas and additional equipment is needed for securing them to the ground. It is a serious disadvantage of these mats that in the event of malfunctioning or damage in a small area, the product needs to be completely replaced.

In the prior art modular removable snow melting devices are also described. Thus for example U.S. Pat. No. 4,814,580 to Carageorge describes a thermal walkway brick with male and female couplers that are mounted on opposite sides of the brick providing for electric modularity only while structural modularity is achieved through the use of mortar. This type of snow melting apparatus necessitates construction by a professional team and does not allow full modularity in all directions. Repair by replacing a single brick is not provided for.

Many other modular snow melting devices of the prior art such as JP2004047314 to Nozawa Sumi have bricks with electrical circuits that enable coupling of the modules in successive lines only. Such systems cannot be used to cover extensive surfaces of different shapes and they have the additional drawback that due to a linear conducting system a failure in one modular element disconnects the whole line of elements extending beyond it.

U.S. Pat. No. 6,278,085 to Abukasm describes a modular snow melting device consisting of flat sheets of rectangular shape, each comprising an electric system and a heat conducting system, that are connectible on all four sides to cover large surfaces of different shapes.

This snow melting device has the drawbacks of necessitating separate electrical connecting means such as male connectors and mechanical attachment means such as plates and screws, resulting in a product design that is cluttered and tedious to use. It is a further drawback of this device that the electrical connecting means can only be introduced horizontally through the length and width edges of the modular plates whereby the covering of large areas with plates connected on all four sides becomes complicated and replacement of defective plates is hardly possible.

It is therefore desirable to provide a modular snow melting system that is suitable for covering both large and small areas due to a complete structural as well as electrical modularity.

It is desirable to provide a modular snow melting system that is laid out above a preexisting surface such that the need for heavy machinery, excavating and renewed paving is eliminated.

It is desirable to provide a modular snow melting system with modular units that are easily connectible on all sides such that areas of different shapes may be covered by assembling the said units.

It is desirable to provide a modular snow melting system with integral mechanical engagement and electrical connecting means and modular units that are designed to accommodate the said engagement means and connecting means.

It is desirable to provide a modular snow melting system with a parallel connection electric system such that failure of one modular unit will not cause failure of other, neighboring units.

It is desirable to provide a modular snow melting system in which each modular unit is adapted for connection to the main power source/control unit.

It is desirable to provide a modular snow melting system with self explanatory, do it yourself elements that eliminates the need for professional help during assembly, dismounting and repair, thus saving time and costs.

It is desirable to provide a modular snow melting system that may be easily disassembled when moving to another house or business premises and that may be repaired by replacing a single surface unit that is malfunctioning.

It is desirable to provide a modular snow melting system with a simplified and clean design that is appealing to the potential customer.

It is desirable to provide a modular coverage system in which electric conducting and heating means are installed to enable snow melting action while it may also be made without electric means to be implemented as a decorative coverage system.

Finally, it is desirable to provide a coverage system for indoor or outdoor areas with or without snow melting action, that is made of modular units available in different geometrical shapes and in a variety of patterns, materials, sizes, textures and colors thus enabling the construction of a decorative coverage according to the user's individual esthetic preferences.

### SUMMARY OF THE INVENTION

A modular coverage system for covering an area of desired shape and size with the purpose of heating the said area in order to prevent snow accumulation or to melt down accumulated snow or for decoration, protection and comfort.

The modular system comprises a plurality of surface units of generally planar shape. The surface units may be made according to any design, rectangular, round, oval, crescent etc. as long as they are suitable to be laid out adjacent to each other, and many kinds of patterns, with a flat or three dimensional finish such as smooth tile pattern, a wooden deck pattern, a brick or pebble pavement or simple pavement pattern, artificial lawn, mosaic, etc. may be applied to them.

In modular coverage systems intended for the purpose of preventing snow accumulation or melting down accumulated snow electric conducting and heating means are located inside the surface unit. Along the outline of the surface unit recessed docking station means are provided in the areas that are designed to be adjacent to the outline of a neighboring surface unit. Thus for example where the surface unit is of rectangular shape a docking station means within a recess is provided along each of the four sides of the surface unit respectively.

Each docking station means comprises one or more electrical connection means and one or more mechanical engagement means. A first surface unit and a second surface unit are interconnected both mechanically and electrically by placing the said first surface unit next to the said second surface unit such that a first docking station means provided in the first surface unit becomes adjacent to a second docking station means provided in the second surface unit and a joint recess with a pair of adjacent docking station means is achieved; superimposing over the said pair of adjacent docking station means an integral connecting plate that is a generally planar unit having a thickness that fits the said joint recess and with a size and shape that are suitable for covering the said pair of adjacent docking station means within the said joint recess. The integral connecting plate is adapted to be mechanically engaged to each of the said pair of adjacent docking station means. Two or more interconnected electrical connection means are disposed in the integral connecting plate for electrically connecting between the electrical connecting means of the said first and second surface units.

A removable docking station cover panel that is a generally planar unit without electrical components, adapted to fit a recess in which a docking station means is disposed, is used to cover docking station means on the sides of the surface unit that remain unattached, and keep them watertight. The docking station panel cover is adapted to be reversibly engaged to the said docking station means by mechanical engagement means.

An electrical docking station cover panel with electrical connection means for connecting to the electrical connection means in a docking station means, and from which an electric cord extends may be attached to a docking station means in a surface unit positioned at any convenient location within the snow melting system to connect the snow melting system to a power source. The electrical docking station cover panel is adapted to be reversibly engaged to the said docking station means by mechanical engagement means.

The electric means in the surface units are connected in a parallel circuit such that electricity supply persists in the event of failure in one of the surface units.

The system is self explanatory, easy to assemble, repair and replace without professional equipment and it may be dismounted and reassembled without loss or damage.

The modular coverage system of the invention may be made without electrical and heating means to be used for decorative and protective purposes.

### BRIEF DESCRIPTION OF THE DRAWINGS

FIG. 1 is a top view of the upper side of a quadrangular surface unit

FIG. 2 is a top view of the upper side of a semicircular surface unit

FIG. 3 is a top view of the upper side of a triangular surface unit

FIG. 4 is a top view of the upper side of a quadrangular surface unit with a brick pavement pattern

FIG. 5 is a top view of the upper side of a quadrangular surface unit with a pebble pavement pattern

FIG. 6 is a top view of the upper side of a quadrangular surface unit with a wooden deck pattern

FIG. 7 is a perspective view of the upper side of the surface unit of FIG. 1

FIG. 8 is a perspective view of the lower side of a docking station cover panel for a modular coverage system according to a preferred embodiment

FIG. 9 is a top view of the docking station cover panel P of FIG. 8

FIG. 10 is a perspective view of a bayonet pin for the modular coverage system of the invention according to a preferred embodiment

FIG. 11 is a perspective view of the lower side of an electric docking station cover panel for a modular coverage system according to the invention according to a preferred embodiment.

FIG. 12 is a perspective view of the lower side of an integral connecting plate for a modular coverage system according to a preferred embodiment

FIG. 13 is a top view of the upper side of an integral connecting plate for a modular coverage system according to a preferred embodiment

FIG. 14 is a perspective view showing the assembly of the surface units of the inventive modular coverage system according to a preferred embodiment

FIG. 15 is a top transparent view of a surface unit in a modular coverage system for snow melting according to a preferred embodiment with an electric circuit and a heating wire

### DETAILED DESCRIPTION OF THE INVENTION

The present invention provides a modular coverage system that is suitable for covering both large and small areas and may be used for covering roofs, driveways, sidewalks, stairs or indoor or outdoor areas of any shape such as porches, entrance areas etc. The modular coverage system of the invention may comprise electric conducting and heating means such as electric wires and heating wires for the purpose of melting snow or preventing the accumulation of snow by heating the ground covered by the modular coverage system.

In accordance with another aspect of the invention the modular coverage system may be made without any electric conducting and heating means and used for decorative or protective purposes.

The inventive modular coverage system is made of surface units available in different geometrical shapes and in a variety of patterns, materials, sizes, textures and colors thus enabling the construction of a decorative coverage according to the user's individual esthetic preferences.

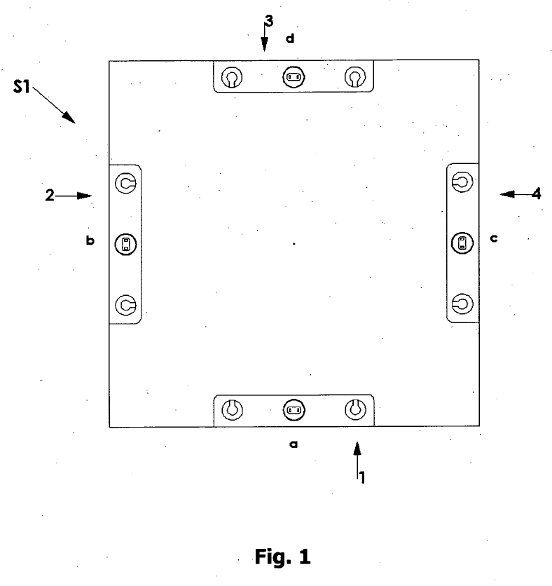

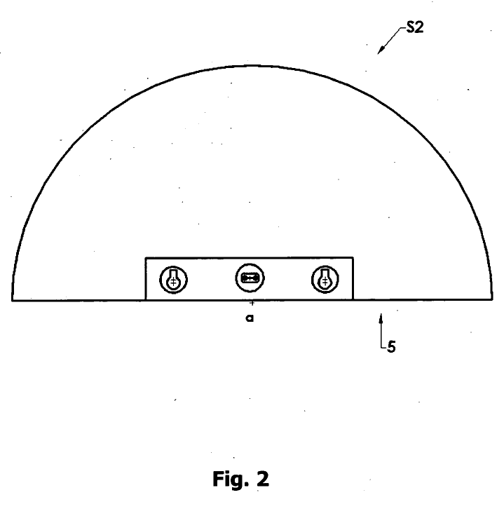

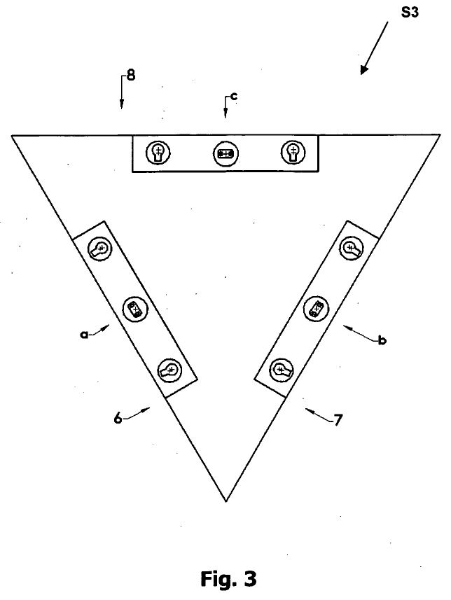

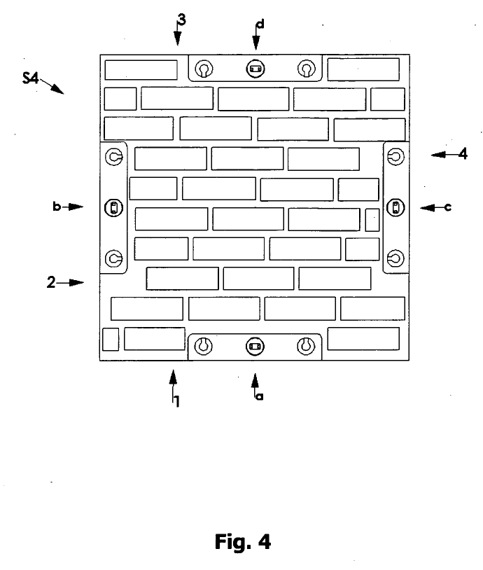

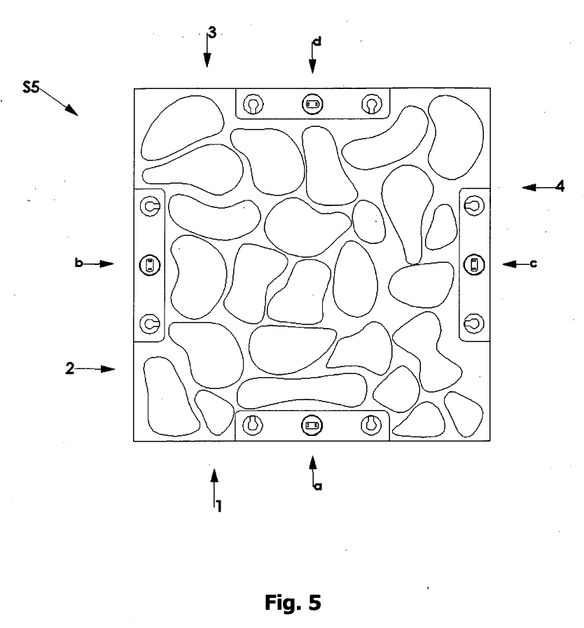

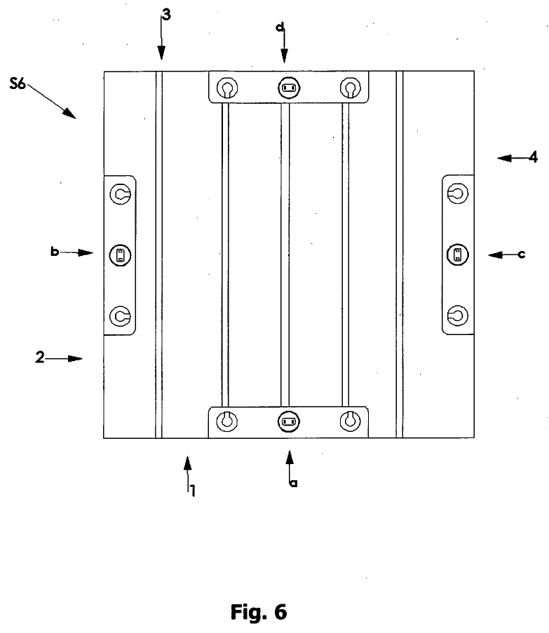

The surface units according to the invention are of a generally planar shape, with a thickness, an upper side and a lower side. As seen in FIGS. 1-3, the surface unit according to the invention may be made in the shape of a quadrangle (FIG. 1), a semi circle (FIG. 2.), a triangle (FIG. 3) and in any other shape that enables the surface units to be laid out adjacent to each other. A few examples of different designs and patterns including three dimensional designs for the upper side of the surface unit are shown in FIGS. 4-6 wherein FIG. 4 shows a brick pavement design, FIG. 5 shows a pebble pavement design and FIG. 6 shows a wooden deck design that may be made of wood or of any synthetic wood imitation. These examples are not intended to be limiting the invention and many other designs such as mosaic, artificial lawn, roof tile design, asphalt pavement design, combinations of artificial lawn and mosaic, mosaic and pebble, synthetic pebble imitation, synthetic brick imitation and any other variations and patterns may be used to achieve a decorative surface. The materials to be used for the surface units may be different kinds of plastic materials, wood, concrete, rubber and any other kind of suitable material.

It is an important advantage of the invention that areas of different shapes may be covered by assembling the said surface units.

As seen in FIGS. 1-6, each of the surface units S1-S6 is formed with one or more recessed docking station means on the upper side of the said surface unit. Thus in FIG. 1 four docking station means a, b, c, d are disposed on the upper side of the surface unit S1 along the four sides 1, 2, 3, and 4 of the said surface unit S1 respectively, in FIG. 2 a single docking station means (a) is disposed on the upper side of the surface unit S2 along the straight side 5 of the said surface unit S2, in FIG. 3 three docking station means a, b, and c are disposed on the three sides 6, 7 and 8 of the surface unit S3 respectively, and in each of FIGS. 4, 5 and 6 four docking station means a, b, c, d are disposed on the upper side of each of the surface units S4, S5 and S6 respectively, along the four sides 1, 2, 3, and 4 of each of the said surface units S4, S5 and S6 respectively. In each of the docking station means mechanical engagement means and electrical connection means are provided, as shown in FIGS. 1-6.

The said docking station means are an important element of the invention that facilitates both electrical and mechanical interconnection of the surface units as will be described and explained in detail hereinbelow. It will be understood that the docking station means may be formed in accordance with a different design and the number of connecting means may be different from that shown in FIGS. 1-6 without departing from the invention and without exceeding the scope of the claims.

In accordance with a preferred embodiment the docking station means may be disposed at one or more angles of the surface unit, such as the four angles of a quadrangular surface unit.

In accordance with one aspect of the invention an electrical circuit and a heating wire are provided inside the surface unit, between the upper side and the lower side of the surface unit and the surface units are electrically connected such that the modular coverage system may be used for heating the covered area and for preventing the accumulation of snow or eliminating snow that has been accumulated.

It is a significant advantage of the invention that the inventive coverage system is laid out on top of a preexisting surface such that snow melting is provided for while the need for heavy machinery, excavating and renewed paving is eliminated. Similarly, where the system is used for roof coverage, removal of the roof tiles is not required due to the external position of the coverage system of the invention.

It is another important advantage of the invention that the connection between the surface units is achieved by integral connecting plates that are inserted from above and received in the recessed docking station means formed on the upper side of the surface units. The integral connecting plates have means for mechanically engaging a pair of neighboring surface units as well as means for electrically connecting between the said pair of neighboring units. In accordance with the invention the electrical engagement means and mechanical connecting means are provided on the lower side of the integral connecting plate and they are easily and reversibly connectable to the mechanical and electrical connection means provided in the recessed docking station means respectively thereby facilitating quick attachment and detachment of the integral connection plates.

Due to the integral connection plates that are inserted from above and detachably attached to the recessed docking station means on the upper side of the surface units, the surface units may be laid out freely in an array that may be altered as many times as necessary and the final preferred array may be assembled effortlessly, without any need for professional assistance. Due to the integral connection plates, in the event of failure in a single surface unit, the faulty unit may be easily detached from the modular coverage assembly and replaced without disassembling a significant part of the assembly.

It is yet another advantage of the inventive surface unit that the electrical connection means in each surface unit are connected in parallel. This circuitry prevents total failure of a single surface unit as a result of failure in a single electrical connection means. The connection between neighboring surface units is also parallel, whereby successive failure of neighboring surface units around a surface unit in which short circuit has occurred is prevented, enabling the heating operation to continue all over the modular coverage assembly.

The inventive coverage assembly is time and cost saving by eliminating the need for professional planning, construction works and professional assistance. Another significant saving of costs is enabled by the feasibility of removing the modular coverage assembly and transferring it to another place when moving house or office.

The inventive modular coverage assembly is made of a very small number of self explanatory, do it yourself elements, this simplified and clean representation making the assembly highly attractive to the potential customer.

### DETAILED DESCRIPTION OF A PREFERRED EMBODIMENT

The invention will be described hereinbelow in accordance with a preferred embodiment. It will be obvious to those versed in the art that changes and modifications may be made without departing from this invention in its broader aspects and, therefore, the appended claims are to encompass within their scope all such changes and modifications as fall within the true spirit and scope of this invention.

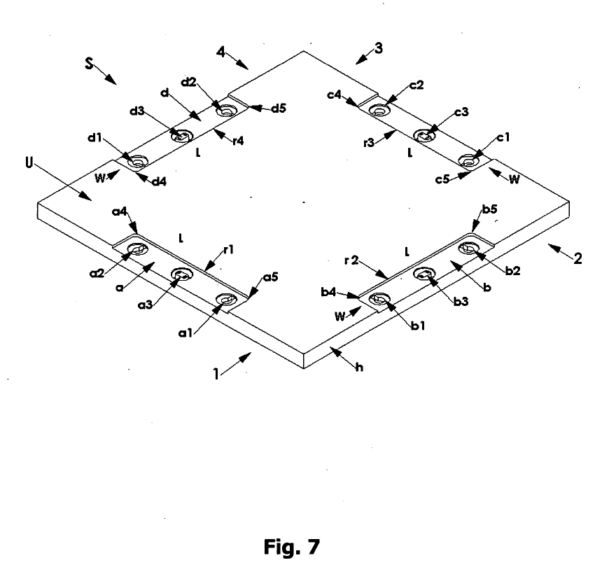

FIG. 7 is a perspective view of the upper side of a surface unit S for a modular coverage assembly in accordance with the preferred embodiment. The surface unit S has a generally planar rectangular shape with a thickness h, four sides 1, 2, 3, and 4, an upper side U. On the upper side U of the surface unit S four docking station means a, b, c and d are provided on each of the sides 1, 2, 3 and 4 of the surface unit S respectively. Each docking station means has a length L and a width w and each of the docking station means a, b, c and d is disposed within a recess r1, r2, r3 and r4 respectively. In the preferred embodiment of FIG. 7, each of the recesses r1, r2, r3 and r4 has a pair of inner curved corners a4 and a5, b4 and b5, c4 and c5, d4 and d5 respectively.

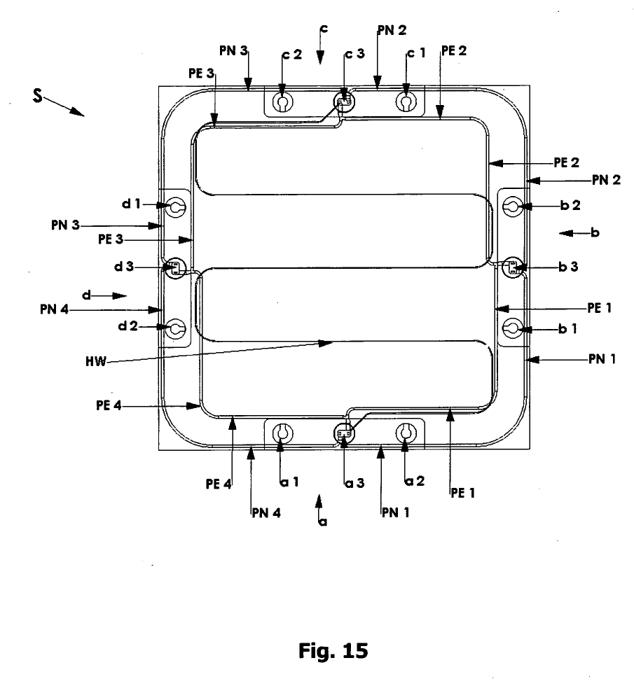

A pair of mechanical engagement means formed as bayonet sockets a1 and a2 are provided in docking station means a. Further pairs of mechanical engagement means formed as bayonet sockets b1 and b2; c1 and c2; d1 and d2 are provided in each of docking station means b, c and d respectively. Between each of the said pairs of bayonet sockets a1 and a2; b1 and b2; c1 and c2; d1 and d2 respectively a female electrical connecting means a3, b3, c3 and d3 is provided. The electrical connecting means a3, b3, c3 and d3 are interconnected in parallel by an electrical circuit that is disposed within the surface unit S. A preferred embodiment of the electrical circuit of the surface unit will be described further below with reference to FIG. 15.

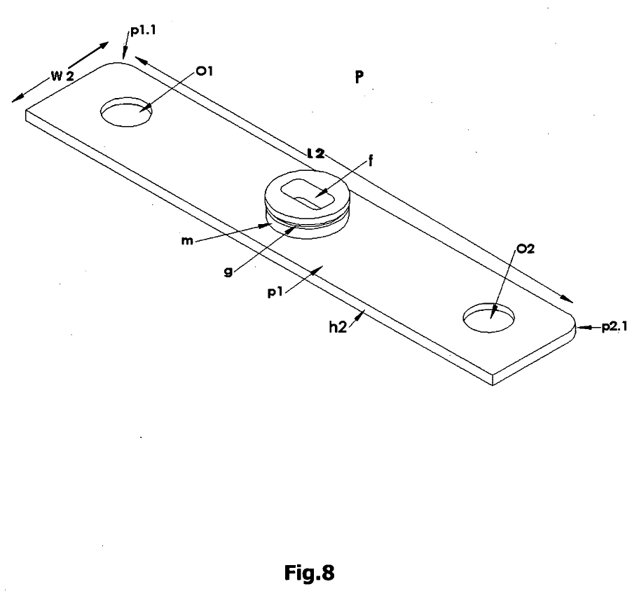

The docking station means a, b, c and d may be kept covered for protection by docking station cover panels during storage and as long as there is no need to connect the surface units. A perspective view of the bottom side P1 of a docking station cover panel P is shown in FIG. 8. The docking station cover panel P is a generally planar plate with a thickness h2, a length L2 and a width w2. The shape and size of the docking station cover panel P allow it to be snugly received in any of the recesses r1, r2, r3, or r4 of FIG. 7 to cover any of the docking station means a, b, c, or d of FIG. 7 respectively. In the preferred embodiment the docking station cover panel P is made with two rounded outer corners p1.1, p2.1 that are adapted to be snugly received in rounded inner corners a4 and a5 of the recess r1 respectively when the docking station means cover panel is received in the recess r1. It will be understood that the recess for the docking station cover panel and accordingly the docking station cover panel may be designed in accordance with many different designs and the design shown in FIGS. 7 and 8 is not intended to be limiting to the invention.

As seen in FIG. 8, that is a perspective view of the lower side of a docking station cover panel P, in the docking station cover panel P two round openings O1 and O2 are provided such that when the docking station cover panel P is received in the recess r1 the round openings O1 and O2 come to overly the sockets a1 and a2 of the docking station means (a) respectively. On the said lower side of the docking station cover panel P, between the two round openings O1 and O2 a sealing means m is provided. Within the sealing means m a hollow recess f is provided such that when the docking station cover panel P is received in the recess r1 the hollow recess f comes to overly the electrical connecting means a3. Around the sealing means m a gasket g is provided for keeping the electrical connecting means a3 watertight. It will be understood that the shape of the sealing means m or the recess for the electrical connecting means a3 are not of the essence of the invention and these elements of the inventive docking station means (a) and docking station cover panel P may be made according to many different designs and still remain within the scope of the claims.

It will be further understood that while the docking station cover panel P has been described in relation to the recess r1 and the docking station means (a), the docking station panel P may be used to cover any of the other docking station means b, c, or d of the surface unit S. It will be further understood that other docking station cover panels, generally identical to the said docking station cover panel P, may be used to cover the docking station means b, c, and d respectively such that two or more of the docking station means are covered at the same time.

The docking station cover panel P is removed from the surface unit S during assembly whereby connection between a pair of neighboring surface units S is enabled. In accordance with the invention, docking station cover panels are left in their original position to cover, protect and keep water tight docking station means that are positioned on the outer margin of the modular coverage system and therefore do not need to be connected to an adjacent docking station means. It is one of the advantages of the inventive modular coverage system that due to the docking station cover panels covering the docking station means that are positioned on the outer margin of the modular coverage system, short circuits as a result of dirt or water reaching the electrical connecting means of the docking station means are prevented.

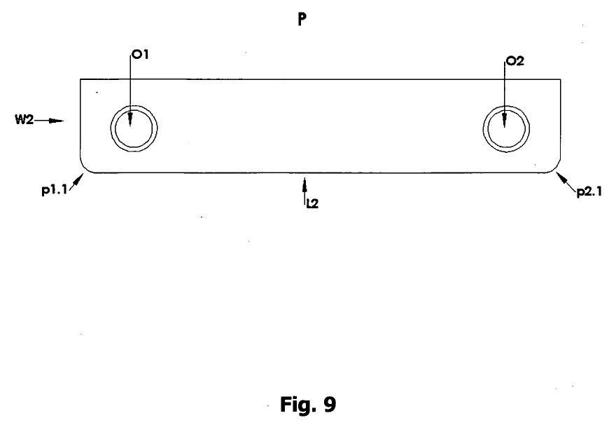

Referring now to FIG. 9, a top view of the docking station cover panel P of FIG. 8 is shown, with length L2, width w2, rounded corners p1.1 and p2.1 and round openings O1 and O2. As seen in FIG. 9, the upper side of the docking station means panel is clear from any electrical or mechanical installations such that when the docking station means a, b, c and d of the surface unit S of FIG. 7 are covered by respective docking station cover panels, a surface unit S with a clean and smooth surface is achieved.

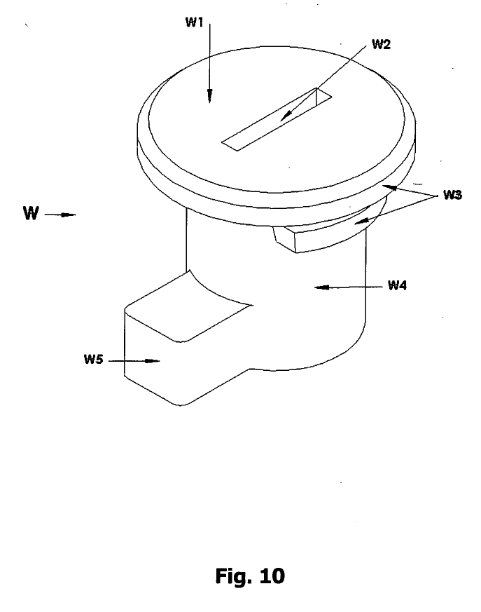

In accordance with the preferred embodiment the docking station cover panel P is attached to the docking station means (a) by driving a first bayonet pin W, best seen in FIG. 10, through the round opening O1 and into the bayonet socket a1 and driving a second bayonet pin W through the round opening O2 and into the bayonet socket a2. The bayonet socket a1 and the first bayonet pin W and similarly the bayonet socket a2 and the second bayonet pin W thus define a bayonet-pin-and-socket connection facilitating the quick attachment and detachment of the docking station cover panel P with respect to the docking station means (a).

Referring now to FIG. 10, the bayonet pin W has a flat head w1 that is formed with a slot w2, the slot w2 being adapted for receiving a tool such as a screwdriver that facilitates the locking of the bayonet pin W into a bayonet socket such as bayonet socket a1 of FIG. 8. The circumference of the head w1 of the bayonet pin W is formed with a bayonet structure w3. A cylindrical stem w4 is downwardly extending from the head w1 and on the end of the cylindrical stem w4 an extension w5 is formed extending at a straight angle from the said cylindrical stem w4. It will be understood that the extension w5 is adapted to secure the bayonet pin and socket connection. It will be further understood that in the inventive system other bayonet pins may be used with a design that is different from the design of the bayonet pin W as long as the bayonet sockets are adapted to receive the bayonet pin. It is an important advantage of the inventive modular coverage system that the docking station cover panels are snugly received in the recesses formed on the upper side of the surface unit and the bayonet pins are formed with a flat head that lies level with the upper surface of the docking station cover panel whereby when the docking station cover panels are attached to the docking station means provided on the surface unit, a smooth surface unit is achieved with a clean and esthetic look and there are no electrical or mechanical devices protruding from the top of the surface unit that may be intrusive and dangerous during use such as cleaning, barefoot walking, or small children playing in the area covered by the modular coverage system etc.

It will be understood that the upper surface of the docking station cover panels may be made in accordance with many different designs and patterns that are compatible with the pattern and design of the upper side of the surface units comprised in the same modular coverage assembly.

It will be understood that the docking station cover panel means may be attached to the docking station means by different mechanical engagement means and while the use of a bayonet-pin-and-socket connection highly facilitates the assembly of the inventive modular coverage system, other mechanical engagement means such as a screw with a threading may be used as long as the docking station has a socket means that is adapted to receive the said attachment means and the attachment means is made with a flat head that lies level with the upper surface of the docking station means panel when the docking station means panel is attached to the docking station means using the said attachment means.

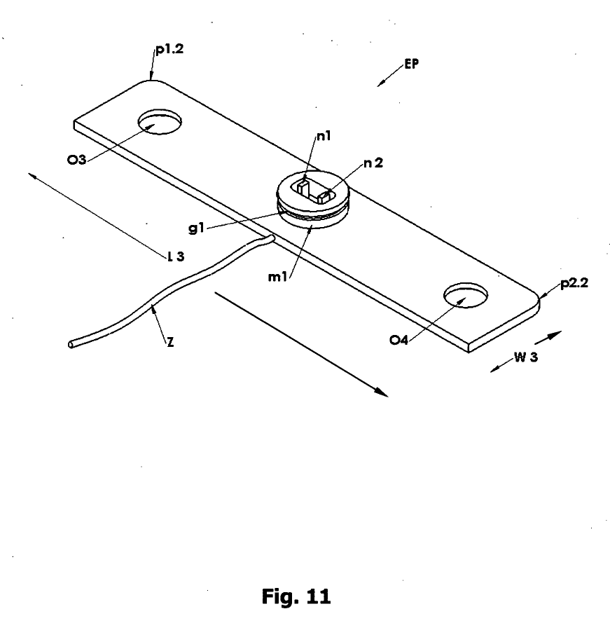

Each of the docking station means a, b, c, and d is adapted to receive an electric cover panel EP. FIG. 11 is a perspective view of the lower side of an electric cover panel EP, that is a generally flat plate of the same size and shape as the docking station cover panel P of FIGS. 8 and 9, with length L3 and width w3 wherein the said length L3 and width w3 are substantially equal to length L2 and width w2 of the docking station cover panel P respectively. The electric cover panel EP is formed with rounded corners p1.2 and p2.2 that snugly fit into the rounded inner corners of a recess with a docking station means such as the rounded inner corners a4 and a5 of the recess r1. In the electric cover panel EP two round openings O3 and O4 are provided such that when the docking station means panel P is received in the recess r1, the round openings O3 and O4 come to overly the bayonet sockets a1 and a2 respectively. Between the two round openings O3 and O4 a sealing means m1 is provided with a gasket g1 that prevents water from reaching the electrical connection means a3 within the docking station means (a) as well as the electrical connection means within the sealing means m1. As seen in FIG. 11, the sealing means m1 is made with a hollow recess f and an electrical connector means (not shown) with a pair of prongs n1 and n2 is provided within the said hollow recess f. The sealing means m1 is positioned in such a manner that when the electric docking station means panel is inserted into the recess r1 the prongs n1 and n2 are received in the electric connector a3 thereby electrically connecting the electrical circuit of the surface unit S to the electrical circuit in the electric docking panel EP. The electric cover panel EP is adapted for connecting to an electricity source or to an electric control means by an electric cord Z that is extending from the electric cover panel EP.

In accordance with the preferred embodiment the electric cover panel EP is attached to docking station means (a) of the surface unit S by driving a bayonet pin W, best seen in FIG. 10, through the round opening O3 and into the bayonet socket a1, and driving a second bayonet pin W through the round opening O4 and into the bayonet socket a2. The bayonet socket a1 and a first bayonet pin W and similarly the bayonet socket a2 and a second bayonet pin W thus define a bayonet-pin-and-socket connection facilitating the quick attachment and detachment of the electric docking station panel with respect to the docking station means. It is an important advantage of the inventive modular coverage system that the electric cover panel EP is snugly received in the recess r1 on the upper side of the surface unit and the bayonet pins W are formed with a flat head that lies level with the upper surface of the docking station means panel whereby when the electric docking station means panel is attached to the surface unit a smooth panel is achieved with a clean and esthetic look and no protrusions remain that may be intrusive and dangerous during use.

It will be understood that the upper surface of the electric cover panel EP may be made in accordance with many different designs and patterns that are compatible with the pattern and design of the upper side of the surface units comprised in the same modular coverage assembly.

It is an important advantage of the inventive surface coverage system that the electric cover panel EP may be attached on any of the surface units such that connection of the surface coverage system to the main power source/control means may be achieved through any of the surface units S.

It is an important advantage of the inventive surface coverage system that the electric cover panel EP and the docking station cover panel P are fully and instantly exchangeable due to being of the same size and shape and due to the quick bayonet pin and socket attachment means. This advantage of the invention facilitates the replacement of any docking station cover panel with an electric docking station panel whereby the surface coverage system may be attached to an electric power source or control means at any point along the said surface coverage system and the attachment point may be later changed as necessary. It will be understood that this advantage of the invention facilitates the creating of surface coverage systems with diverse configurations and placing them in different locations in relation to the electric power source. The above advantage also facilitates disassembling the inventive surface coverage system and reassembling it in a different orientation, in a different configuration or at a different location, thereby lending increased versatility to the inventive system.

A main advantage of the surface coverage system of the invention is the full electrical and mechanical modularity achieved by the use of an integral connecting plate.

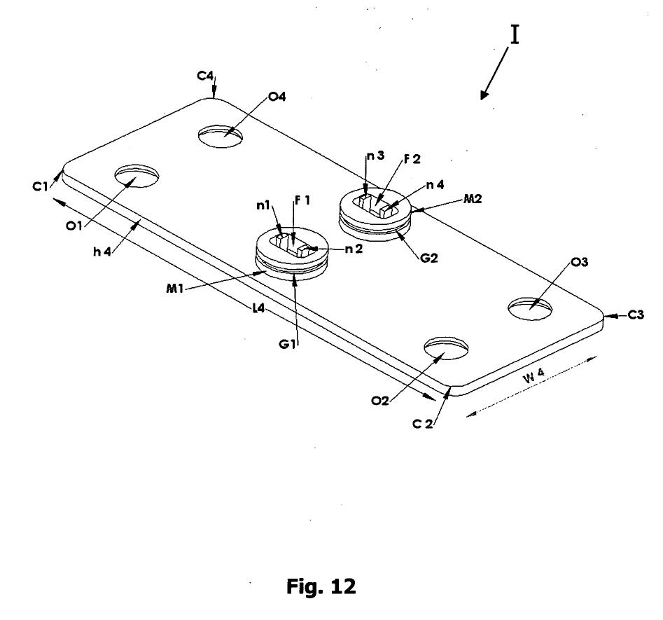

Referring now to FIG. 12 that is a perspective view of the lower side of the novel integral connecting plate of the invention, the integral connecting plate I is a generally planar plate with a thickness h4, a length L4 and a width w4. The integral connecting plate I is formed with four curved corners C1, C2, C3 and C4.

As seen in FIG. 12, in the integral connecting plate I a first pair of round openings O1 and O4 are provided proximally to the curved corners C1 and C4 and inwardly removed from the said curved corners C1 and C4 respectively. Further in the integral connecting plate I a second pair of round openings O2 and O3 are provided proximally to the curved corners C2 and C3 and inwardly removed from the said curved corners C2 and C3 respectively. Between the said first pair of round openings O1; O4 and the said second pair of round openings O2; O3 a pair of sealing means M1 and M2 is provided with watertight gaskets G1 and G2 respectively. The sealing means M1 is formed with a hollow recess F1 and the sealing means M2 is formed with a hollow recess F2. A first electrical connecting means (not shown) with a pair of prongs n1, n2 is provided in the hollow recess F1 and a second electrical connecting means (not shown) with a pair of prongs n3 and n4 is provided in the hollow recess F2 wherein the said first and second electrical connecting means are interconnected.

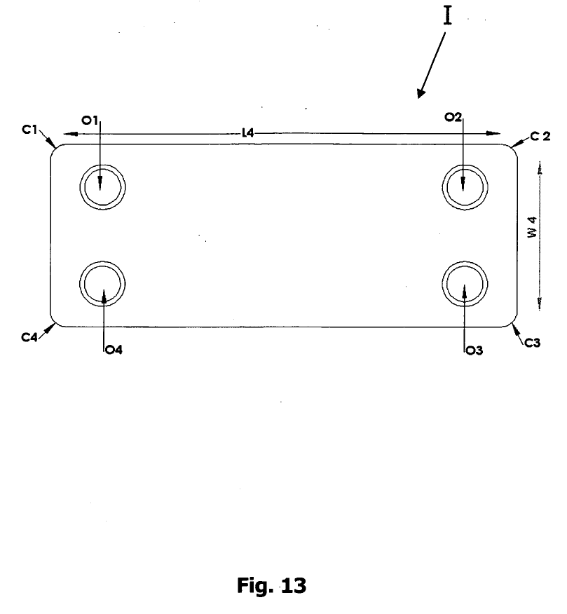

FIG. 13 shows the upper side of the integral connecting plate I in a top view, showing the length L4, the width w4, the first pair of round openings O1 and O4, the second pair of rounded openings O2 and O3 and the curved corners C1, C2, C3 and C4 of the integral connecting plate I.

It will be understood that the upper surface of the integral connecting plate I may be made in accordance with many different designs and patterns that are compatible with the pattern and design of the upper side of the surface units comprised in the same modular coverage assembly.

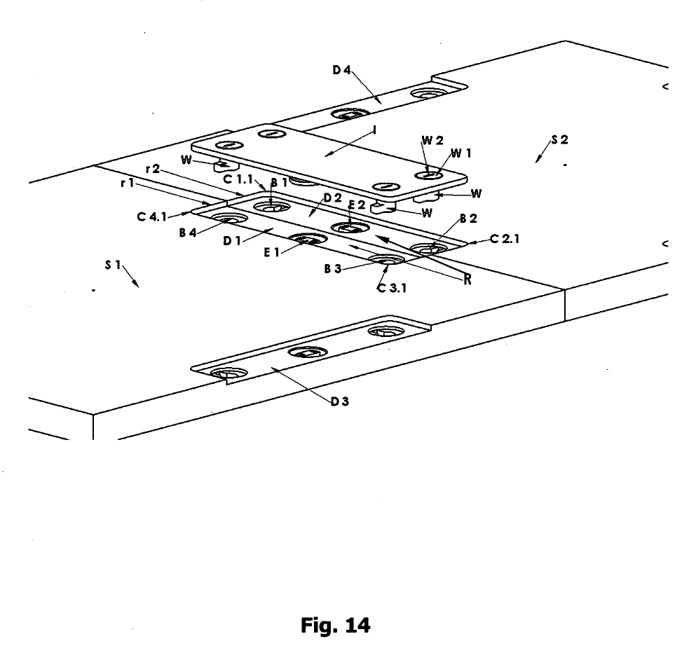

The implementation of the inventive integral connecting plate I for achieving full mechanical as well as electrical connection between the surface units of the invention is best described with reference to FIG. 14.

FIG. 14 shows two neighboring surface units S1 and S2 that are placed next to each other such that a combined recess R is formed by the two respective recesses r1 and r2 of the two docking station means D1 and D2 on the adjacent sides of the two neighboring surface units S1 and S2. As seen in FIG. 14, within the combined recess R the bayonet sockets B1 and B2 of the surface unit S2 are facing the bayonet sockets B3 and B4 of the surface unit S1 respectively and the electrical connection E1 of the surface unit S1 is facing the electrical connection E2 of the surface unit S2.

Referring again to FIG. 14, the integral connecting plate I of FIG. 12 is lowered over the combined recess R such that it is snugly received in the said combined recess R. The integral connecting plate I is shown with four bayonet pins W inserted in the round openings O1, O4 and O2, O3 of the said integral connecting plate I. The four bayonet pins W enable quick and reversible attachment of the integral connecting plate I to the surface units S1 and S2 by driving the four bayonet pins W into the four bayonet sockets B1, B2, B3 and B4 within the combined recess R. It will be understood that due to the said attachment of the integral connecting plate I to the surface units S1 and S2 a mechanical connection is achieved between the said surface units S1 and S2.

It is an important advantage of the inventive integral connecting plate I that when the said integral connecting plate I is inserted into the said combined recess R the prongs n1 and n2 are received in the electric connector means E1 and the prongs n3 and n4 are received in the electric connector means E2 such that the electrical circuit of the surface unit S1 is connected to the electrical circuit of the surface unit S2 whereby mechanical as well as electrical connection is achieved by using a single connecting means.

It is an important advantage of the invention that when the integral connecting plate I has been received in the combined recess R, the upper side of the said integral connecting plate I comes to lie level with the upper side of the surface unit S1 and with the upper side of the surface unit S2. It is another advantage of the invention that the bayonet pins W are formed with a flat head that lies level with the upper side of the integral connecting plate I such that a modular coverage system with a clean and esthetic look is achieved with no attachment means that might be intrusive and. dangerous during use protruding from the surface of the said modular coverage system. It is yet another advantage of the invention, best seen in FIG. 13, that the upper side of the integral connecting plate is clear from any electrical or mechanical installations such that when the integral connecting plate I is received within the said recess R, a section of a modular coverage system with a clean and smooth surface is achieved that may have a flat or three dimensional pattern.

The invention is not limited to the mechanical engagement means and electrical connection means described with reference to FIGS. 7-15. Thus for example the mechanical engagement means disposed in the said docking station means may be male engagement means while the mechanical engagement means disposed on the said docking station cover panels, electric cover panels and integral connecting plates may be female engagement means, and the electrical connection means disposed in the said docking station means may be male electrical connection means while the electrical connection means disposed on the electric cover panel and the integral connecting plate may be female connecting means, as long as the said engagement and connection means disposed on the said docking station means are adapted to be connected to the engagement and connecting means provided on the said docking station cover panels, electric cover panels and integral connecting plates.

It will be understood that the docking station means D3 and D4 facilitate the attachment of further surface units to the surface units S1 and S2 of FIG. 14 by using additional integral connecting plates as described hereinabove.

It will be further understood that in a decorative coverage system integral connecting plates without electrical connecting means may be used to connect the surface units.

The invention thus enables the construction of a modular coverage system with self explanatory, do it yourself elements that eliminates the need for professional help during assembly, dismounting and repair, thus saving considerable time and costs.

Referring now to FIG. 15, a transparent top view of a surface unit S for a modular coverage and snow melting system is shown, with four docking station means (a), b, c and d wherein in the docking station (a) an electric connection means a3 is disposed between a pair of bayonet sockets a1, a2; in the docking station b an electric connection means b3 is disposed between a pair of bayonet sockets b1, b2, in the docking station c an electric connection means c3 is disposed between a pair of bayonet sockets c1, c2 and in the docking station d an electric connection means d3 is disposed between a pair of bayonet sockets d1, d2. As seen in FIG. 15, in the surface unit S a heating wire HW and an electric circuit for supplying current to the said heating wire HW are provided. The electric circuit comprises the said electric connection means a3, b3, c3 and d3 wherein the said electric connection means a3, b3, c3 and d3 are connected in parallel. As seen in FIG. 15, electric connection means a3 and b3 are interconnected by a positive electric wire PE1 and a negative electric wire PN1, electric connection means b3 and c3 are interconnected by a positive electric wire PE2 and a negative electric wire PN2, electric connection means c3 and d3 are interconnected by a positive electric wire PE3 and a negative electric wire PN3 and electric connection means d3 and a3 are interconnected by a positive electric wire PE4 and a negative electric wire PN4.

In the preferred embodiment shown in FIG. 15, the heating wire HW is made with a number of S shaped curves. It will be understood however that this is not meant to be limiting the invention and the heating wire HW may be made in accordance with many other designs, such as an angular “zig-zag” design as known in the art. As seen in FIG. 15, a first end of the heating wire HW is connected to the electric connecting means a3 and a second end of the said heating wire HW is connected to the electric connecting means c3.

In accordance with the preferred embodiment, an electric cover panel such as the electric cover panel EP of FIG. 11 may be used to connect the surface unit S to a main electrical source or electrical control means wherein the said electric cover panel EP may be attached to any of the docking station means a, b, c or d of FIG. 15. It will be understood that where the electric cover panel EP is attached to the docking station means (a), the connection means a3 will receive the prongs n1 and n2 whereby electric current from the said main source or control means will enter the electric circuit through the said connection means a3, to be distributed through the negative electric wires PN1, PN2, PN3 and PN4, through the positive electric wires PE1, PE2, PE3 and PE4, through the connection means b3, c3 and d3 and through the heating wire HW, causing heat to be generated in the said heating wire HW.

It will be understood by those versed in the art that the above described design of the electric circuit of FIG. 15 has the important advantage of a redundancy that enables continuous heating operation of the surface unit S in the event of failure in one or more of the said negative electric wires NE1, NE2, NE3 and NE4 or one or more of the said positive electric wires PE1, PE2, PE3 and PE4 as long as the connection between the electric connection means a3 and the electric cover panel EP is operational.

The surface unit S may be electrically connected to one or more neighboring surface units by using a suitable number of integral connection panels I as shown and described hereinabove with respect to FIG. 14 for connecting one or more of the docking station means a, b, c, and d to a suitable number of adjacent docking station means provided in the said neighboring surface units.

It will be understood by those versed in the art that in accordance with a main advantage of the inventive modular coverage system, the parallel circuit provided within the surface unit S enables supply of electric current to each of the electric connection means a3, b3, c3 and d3 separately such that failure in current supply to any of the electric connection means a3, b3, c3 and d3 will be compensated by current supply from neighboring surface units S via any of the remaining electronic connection means.

It will be further understood by those versed in the art that in accordance with another important advantage of the inventive modular coverage system, the said parallel circuit provided within the surface unit S prevents failure of the surface units connected to the said surface unit S in the event of failure in one or more of the electric connection means a1, a2, a3 and a4 of the said surface unit S.

It is further envisaged in the framework of the present invention that the docking station means may be disposed on the corners of each of the said surface units and the integral connection plate may be adapted to cover and mechanically as well as electrically connect four adjacent docking station means. It will be understood that by interconnecting four surface units in this manner double redundancy is achieved.

It is yet another advantage of the inventive modular coverage system that in accordance with a second embodiment it may be adapted for solely decorative or coverage purposes by omitting the heating wires and the electric connections of the surface units as well as the electric connections of the integral connecting plate. It will be understood that no electrical cover panels are required for such a decorative modular coverage system and that in this embodiment the integral connecting plate will still be implemented for mechanically connecting the surface units of the invention.

It is one of the main advantages of the invention that the same moulds may be used for a modular coverage system with electrical connection means and heating wires and for a modular coverage system without electrical connection means or heating wires, whereby design and production costs are considerably lowered.

1. A modular coverage system for preventing an outdoor area from accumulation of snow comprising:
a. a plurality of surface units of generally planar shape wherein electrical heating and conducting means are disposed inside the said surface units and docking station means are provided on the upper side of the said surface units along the outline of the said surface units, each of the said docking station means being disposed in a recess and each of the said docking station means comprising mechanical engagement means and electrical connecting means, the said electric connecting means being connected in parallel;
b. a plurality of docking station cover panel means of generally planar shape for covering and protecting the said docking station means, the said docking station cover panel means being adapted to be snugly received in a recess in which a docking station means is disposed and the said docking station cover panel means comprising watertight sealing means and the said docking station means further comprising mechanical engagement means for reversibly attaching the said docking station cover panel means to the said docking station means and;
c. a plurality of complementary mechanical engagement means adapted to be engaged to the said mechanical engagement means comprised in the said docking station means;
d. a plurality of integral connecting panel means of generally planar shape wherein on the lower side of the said integral connecting panel means complementary electrical connecting means are provided for connecting to the said electrical connecting means within the said docking station means,
the said integral connecting panel means being adapted to be snugly received in a combined recess that is formed when a first surface unit with a first recess and a first docking station means disposed in the said first recess is placed next to a second surface unit with a second recess and a second docking station means disposed in the said second recess such that the said integral connecting panel means is mechanically engaged with the said combined recess by the said complementary mechanical engagement means;
Whereby the said first and second surface units are both mechanically engaged and electrically connected by the said integral connecting means;
e. and the said modular coverage system further comprises an electrical means for connecting the said modular coverage system to a main electrical source, such that when the said electrical means is connected to the said main source, the said modular coverage system is enabled to heat the said surface area whereby snow accumulation is prevented and accumulated snow is melted down.

2. A surface unit of quadrangular shape in a modular coverage system according to claim 1 wherein a docking station means disposed in a recess is provided on each of the four corners of the said surface unit on the upper side of the said surface unit and the said integral connecting panel means is adapted to be snugly received in a quadruple recess that is formed when four surface units are placed next to each other such that two sides of each of the said surface units are brought to lie adjacent to two sides of a second unit and the head angles of the said corners of the said surface units are juxtaposed, whereby the said four surface units are mechanically interconnected.

3. A modular coverage system according to claim 1 wherein the said means for connecting the said modular coverage system to the said main electrical source is an electric cover panel means of a generally planar shape, the said electric cover panel means being adapted to be received in a recess formed in a surface unit in which a docking station means is disposed, the said electric cover panel comprising complementary electric connection means for connecting to the said electrical connecting means within the said docking station means and the said electrical cover panel means being adapted to be mechanically engaged with the said docking station means by the said complementary mechanical engagement means;
The said electrical cover means further comprising an electrical connection cord means for connecting the said electric cover means to the said main electrical source.

4. A modular surface coverage system according to claim 1 wherein the said electrical connecting means are female electrical connecting means and the said complementary electrical connecting means are male electrical connecting means that are received in the said female electrical connection means.

5. A modular coverage system according to claim 1 wherein the said mechanical engagement means comprised in the said docking station means are socket means and the said complementary mechanical engagement means are bayonet pin means that are introduced into the said socket means.

6. A modular coverage system according to claim 1 wherein the said means for connecting the said modular coverage system to the said main power source is an electric cover panel means of a generally planar shape, the said electric cover panel means being adapted to be received in a recess formed in a surface unit in which a docking station means is disposed, the said electric cover panel means comprising a male electrical connection means that is downwardly extending from the lower side of the said electric cover panel means, such that the said male electrical connection means is received by the said female electrical connection means provided in the said docking station means to electrically connect the said electric cover panel to the said surface unit, and wherein one or more openings are provided in the said electric cover panel whereby the said electric cover panel is mechanically engaged with the said docking station means by driving the said complementary mechanical engagement means through the said openings and into the said socket means, the said electric cover panel further comprising an electric cord that extends from the said electric cover panel for connecting the said modular coverage system to a main power source.

7. A modular coverage system according to claim 1 wherein the said docking station cover panel means is made with a watertight sealing means.

8. A modular coverage system according to claim 1 wherein the said docking station cover panel means is adapted to be engaged with a docking station means by driving the said complementary mechanical engagement means through openings provided in the said docking station cover panel means and into the said socket means provided in the said docking station means.

9. A modular coverage system according to claim 1 wherein the said mechanical engagement means is a bayonet pin and the said socket means is a bayonet socket that is adapted to form a bayonet pin and socket connection with the said bayonet pin.

10. A modular coverage system according to claim 1 wherein the said area is an outdoor ground surface.

11. A modular coverage system according to claim 1 wherein the said area is a roof surface.

12. A modular coverage system according to claim 1 wherein the said surface units or any of them are formed with a triangular design.

13. A modular coverage system according to claim 1 wherein the said surface units or any of them are formed with a quadrangular design.

14. A modular coverage system according to claim 1 wherein the said surface units or any of them are formed in the shape of a rectangle.

15. A modular coverage system according to claim 1 wherein the said surface units or any of them are formed with a semicircular design.

16. A modular coverage system according to claim 1 wherein the upper side of the said surface units or any of them is formed with a three dimensional pattern.

17. A modular coverage system according to claim 1 wherein the upper side of the said surface units or any of them is formed with a pebble pavement design made of natural or synthetic imitation materials.

18. A modular coverage system according to claim 1 wherein the upper side of the said surface units or any of them is formed with a brick paving design made of natural or synthetic imitation materials.

19. A modular coverage system according to claim 1 wherein the upper side of the said surface units or any of them is formed with a wooden deck design made of natural or synthetic imitation materials.

20. A modular coverage system according to claim 1 wherein the upper side of the said surface units or any of them is formed with a mosaic design made of natural or synthetic imitation materials.

21. A modular coverage system according to claim 1 wherein the upper side of the said surface units or any of them is formed with an artificial lawn design.

22. A modular coverage system according to claim 1 wherein the upper side of the said surface units is formed with an asphalt pavement design made of natural or synthetic imitation materials.

23. A modular coverage system according to claim 1 wherein the upper side of the said surface units is formed in accordance with a combination of two or more designs.

24. A modular coverage system for covering an indoor or outdoor area comprising:
a. a plurality of surface units of generally planar shape wherein docking station means are provided on the upper side of the said surface units along the outline of the said surface units, each of the said docking station means being disposed in a recess and each of the said docking station means comprising mechanical engagement means; and
b. A plurality of docking station cover panel means of generally planar shape for covering and protecting the said docking station means, the said docking station cover panel means being adapted to be snugly received in a recess in which a docking station means is disposed and the said docking station cover panels comprising complementary mechanical engagement means for reversibly engaging the said docking station cover panel means to the said docking station means; and
c. a plurality of integral connecting panel means of generally planar shape, the said integral connecting panel means being adapted to be snugly received in a combined recess that is formed when a first surface unit with a first recess and a first docking station means disposed in the said first recess is placed next to a second surface unit with a second recess and a second docking station means disposed in the said second recess
d. and a plurality of complementary mechanical engagement means for reversibly attaching the said integral connecting panel means to the said docking station means
Wherein the said modular coverage system is adapted to be used for decorative and protective purposes.

25. A modular coverage system according to claim 24 wherein the said mechanical engagement means comprised in the said docking station means are socket means and the said complementary mechanical engagement means are bayonet pin means that are introduced into the said socket means.

26. A modular coverage system according to claim 24 wherein the said docking station cover panel means is adapted to be engaged with a docking station means by driving the said complementary mechanical engagement means through openings provided in the said docking station cover panel means and into the said socket means provided in the said docking station means.

27. A modular coverage system according to claim 24 wherein the said mechanical engagement means is a bayonet pin and the said socket means is a bayonet socket that is adapted to form a bayonet pin and socket connection with the said bayonet pin.

28. A modular coverage system according to claim 24 wherein the said area is an outdoor ground surface.

29. A modular coverage system according to claim 24 wherein the said area is an indoor floor surface.

30. A modular coverage system according to claim 24 wherein the said area is a roof surface.

31. A modular coverage system according to claim 24 wherein the said surface units or any of them are formed with a triangular design.

32. A modular coverage system according to claim 24 wherein the said surface units or any of them are formed with a quadrangular design.

33. A modular coverage system according to claim 24 wherein the said surface units or any of them are formed in the shape of a rectangle.

34. A modular coverage system according to claim 24 wherein the said surface units or any of them are formed with a semicircular design.

35. A modular coverage system according to claim 24 wherein the upper side of the said surface units or any of them is formed with a three dimensional pattern.

36. A modular coverage system according to claim 24 wherein the upper side of the said surface units or any of them is formed with a pebble pavement design made of natural or synthetic imitation materials.

37. A modular coverage system according to claim 24 wherein the upper side of the said surface units or any of them is formed with a brick paving design made of natural or synthetic imitation materials.

38. A modular coverage system according to claim 24 wherein the upper side of the said surface units or any of them is formed with a wooden deck design made of natural or synthetic imitation materials.

39. A modular coverage system according to claim 24 wherein the upper side of the said surface units or any of them is formed with a mosaic design made of natural or synthetic imitation materials.

40. A modular coverage system according to claim 24 wherein the upper side of the said surface units or any of them is formed with an artificial lawn design.

41. A modular coverage system according to claim 24 wherein the upper side of the said surface units is formed with an asphalt pavement design made of natural or synthetic imitation materials.

42. A modular coverage system according to claim 24 wherein the upper side of the said surface units is formed in accordance with a combination of two or more designs.

43. A surface unit of quadrangular shape in a modular coverage system according to claim 24 wherein a docking station means disposed in a recess is provided on each of the four corners of the said surface unit on the upper side of the said surface unit and the said integral connecting panel means is adapted to be snugly received in a quadruple recess that is formed when four surface units are placed next to each other such that two sides of each of the said surface units are brought to lie adjacent to two sides of a second unit and the head angles of the said corners of the said surface units are juxtaposed, whereby the said four surface units are mechanically interconnected.
